(19) United States
(12) Patent Application Publication
(10) Pub. No.: US 2024/0178380 A1
(43) Pub. Date: May 30, 2024

(54) BATTERY AND METHOD OF PRODUCING POSITIVE ELECTRODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 18/483,567

(22) Filed: Oct. 10, 2023

(30) Foreign Application Priority Data
Nov. 28, 2022 (JP) 2022-189197

(51) Int. Cl. H01M 4/38; H01M 4/36; H01M 4/505; H01M 4/525

(52) U.S. Cl. CPC H01M 4/382; H01M 4/362; H01M 4/505; H01M 4/525; H01M 2004/028

(57) ABSTRACT

A battery includes a positive electrode, a negative electrode, and an electrolyte. The positive electrode includes a positive electrode active material. The positive electrode active material includes a lithium nickel composite oxide. The lithium nickel composite oxide includes Fe. An XAFS spectrum of a K-absorption edge of Pe in the positive electrode has a peak top in a range of 7132±2 eV.

### CROSS REFERENCE TO RELATED APPLICATIONS

This nonprovisional application is based on Japanese Patent Application No. 2022-189197 filed on Nov. 28, 2022 with the Japan Patent Office, the entire contents of which are hereby incorporated by reference.

### BACKGROUND

### Field

The present disclosure relates to a battery and a method of producing a positive electrode active material.

### Description of the Background Art

Japanese Patent Application Laid-Open No. 2010-021125 discloses a lithium composite metal oxide containing nickel, manganese, and iron.

### SUMMARY

It has been considered to add iron (Fe) to a lithium nickel composite oxide (LNO). Hereinafter, LNO to which Fe is added is also referred to as “LNO-Fe”. The LNO-Fe can have a higher output than the LNO. However, the LNO-Fe tends to have a decreased initial capacity as compared with the LNO. Therefore, it is an object of the present disclosure to reduce a decrease in initial capacity in the LNO-Fe.

1. A battery includes a positive electrode, a negative electrode, and an electrolyte. The positive electrode includes a positive electrode active material. The positive electrode active material includes a lithium nickel composite oxide. The lithium nickel composite oxide includes iron. An X-ray absorption fine structure spectrum at a K-absorption edge of the iron in the positive electrode has a peak top in a range of 7132±2 eV.

In the LNO-Fe, Fe tends to become trivalent. When the LNO-Fe includes the trivalent Fe, it is considered that divalent nickel (Ni) is increased in order to compensate for imbalance of charges in the compound as a whole. The divalent Ni is likely to occupy a lithium (Li) site. A phenomenon in which Ni, which should be present at a Ni site in the first place, is introduced into the Li site is also referred to as “cation mixing”. It is considered that the initial capacity is decreased by the cation mixing.

When Fe is present to be less than trivalent in the LNO-Fe, the cation mixing can be reduced. The valence of Fe can be confirmed in an X-ray absorption fine structure (XAFS) spectrum. That is, when the XAFS spectrum at the K-absorption edge of Fe has a peak top in the range of 7132±2 eV in the XAFS measurement of the positive electrode, it is considered that Fe can be present to be less than trivalent.

2. In the battery according to “1”, the lithium nickel composite oxide may include the iron at a mass fraction of 1 to 2%, for example.

When the content of Fe is 1 to 2%, a balance between an output and an initial capacity tends to be excellent, for example. It should be noted that a numerical range such as “m to n %” includes an upper limit value and a lower limit value. That is, “m to n %” indicates a numerical range of “m % or more and n % or less”. Further, “m % or more and n % or less” includes “more than m % and less than n %”.

3. In the battery according to “1” or “2”, the lithium nickel composite oxide may include at least one selected from a group consisting of a lithium-nickel-cobalt-manganese composite oxide and a lithium-nickel-cobalt-aluminum composite oxide, for example.

In addition to Ni and Fe, the LNO-Fe may include cobalt (Co), manganese (Mn), aluminum (Al), or the like, for example.

4. A method of producing a positive electrode active material includes the following (a) to (c) in this order.

(a) A lithium nickel composite oxide including iron is prepared.

(b) A mixture is formed by mixing the lithium nickel composite oxide with a reducing agent.

(c) The positive electrode active material is produced by heating the mixture under an inert atmosphere.

When the mixture of the LNO-Fe and the reducing agent is heated under the inert atmosphere, the valence of Fe is reduced to be less than trivalent, for example.

5. In the method of producing the positive electrode active material according to “4”, the lithium nickel composite oxide may include at least one selected from a group consisting of a lithium-nickel-cobalt-manganese composite oxide and a lithium-nickel-cobalt-aluminum composite oxide, for example. The lithium nickel composite oxide may include the iron at a mass fraction of 1 to 2%. The reducing agent may include, for example, an ascorbic acid.

For example, the ascorbic acid or the like can be used as the reducing agent.

The following describes an embodiment of the present disclosure (hereinafter, simply referred to as “the present embodiment”) and an example of the present disclosure (hereinafter, simply referred to as “the present example”). It should be noted that the present embodiment and the present example do not limit the technical scope of the present disclosure. The present embodiment and the present examples are illustrative in any respects. The present embodiment and the present examples are non-restrictive in any respects. The technical scope of the present disclosure includes any modifications within the scope and meaning equivalent to the terms of the claims. For example, it is initially expected to extract freely configurations from the present embodiment and the present example and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram of a battery according to the present embodiment.

FIG. 2 shows an example of an XAFS spectrum.

FIG. 3 is a schematic flowchart of a method of producing a positive electrode active material according to the present embodiment.

FIG. 4 is a table showing the production conditions of the positive electrode active material and the initial capacity.

### DESCRIPTION OF THE PREFERRED EMBODIMENTS

### 1. Battery

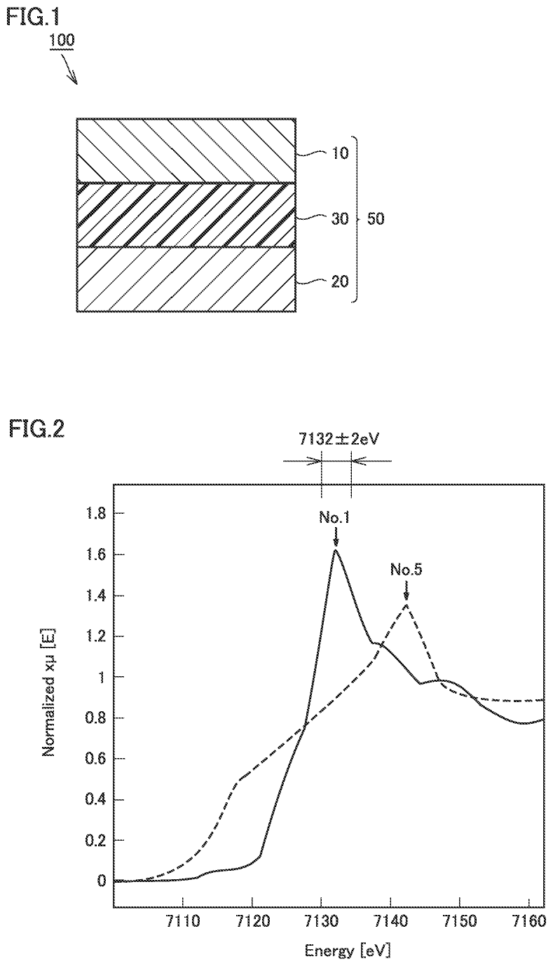

FIG. 1 is a conceptual diagram of a battery according to the present embodiment. The battery 100 is a lithium ion battery. The battery 100 includes a power generation element 50. The power generation element 50 may be housed in an exterior body (not shown). The exterior body may have any form. The exterior body may be, for example, a metal case, a pouch made of a metal foil laminate film, or the like. The case may be, for example, prismatic or cylindrical.

The power generation element 50 includes a positive electrode 10, a negative electrode 20, and an electrolyte 30. That is, the battery 100 includes the positive electrode 10, the negative electrode 20, and the electrolyte 30. The power generation element 50 may have any form. The power generation element 50 may be, for example, a laminated type or a wound type.

### 1-1. Positive Electrode

The positive electrode 10 may be, for example, a sheet. The positive electrode 10 may include, for example, a positive electrode current collector and a positive electrode active material layer. The positive electrode current collector may include, for example, an Al foil or the like. The positive electrode active material layer may be disposed on the surface of the positive electrode current collector. The positive electrode active material layer includes a positive electrode active material. That is, the positive electrode 10 includes a positive electrode active material. The positive electrode active material layer may further include a conductive material, a binder, and the like in addition to the positive electrode active material. The conductive material may form an electron conduction path in the positive electrode active material layer. The conductive material may include, for example, at least one selected from the group consisting of carbon black [e.g., acetylene black (AB), Ketjenblack®, etc.], vapor grown carbon fiber (VGCF), carbon nanotubes (CNT), and graphene flakes (GF). The amount of the conductive material to be blended may be, for example, 0.1 to 15 parts by mass with respect to 100 parts by mass of the positive electrode active material. The binder may adhere the positive electrode active material layer to the positive electrode current collector. The binder may contain, for example, at least one selected from the group consisting of polyvinylidene difluoride (PVdF), vinylidene fluoride-hexafluoropropylene copolymer (PVdF-HFP), polytetrafluoroethylene (PTFE), carboxymethyl cellulose (CMC), and polyacrylic acid (PAA). The amount of the binder to be blended may be, for example, 0.1 to 10 parts by mass based on 100 parts by mass of the positive electrode active material.

### Positive Electrode Active Materials

The positive electrode active material may be, for example, a particle group. The positive electrode active material may have, for example, a D50 of 1 to 30 μm. “D50” denotes a particle diameter at which the accumulated frequency from the smaller particle diameter reaches 50% in the particle size distribution based on volume. The particle size distribution can be measured by a laser diffraction particle size distribution measuring apparatus.

The positive electrode active material may cause a positive electrode reaction. The positive electrode active material includes a lithium nickel composite oxide (LNO). LNO includes Fe. That is, the positive electrode active material contains LNO-Fe. LNO-Fe may have any crystal structure. The crystal structure may be, for example, a lamellar rock salt type or a cubic rock salt type. In LNO-Fe, Fe may be, for example, an interstitial solid solution atom or a substitutional solid solution atom. The content of Fe in LNO-Fe may be, for example, a mass fraction of 0.1 to 3%, 0.1 to 2.5%, 1 to 2.5%, or 1 to 2%. When the Fe content is 1 to 2%, for example, the balance between the output and the initial capacity tends to be good.

The LNO-Fe may contain, for example, at least one selected from the group consisting of a lithium-nickel-cobalt-manganese composite oxide and a lithium-nickel-cobalt-aluminum composite oxide.

LNO-Fe may have, for example, a composition represented by the following general formula:

Li₁₋ₐ(NiₓM₁₋ₓ)_{1-y}Fe_{y}O₂

In the general formula, a, x, and y may satisfy, for example, a relationship of −0.5≤a≤0.5, 0<x≤1, and 0.001≤y≤0.05. M may contain, for example, at least one selected from the group consisting of Co, Mn and Al.

In the general formula, x may satisfy, for example, the relationship of 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1.

In the general formula, y may satisfy, for example, a relationship of 0.01≤y≤0.05, 0.01≤y≤0.04, or 0.02≤y≤0.04.

LNO-Fe may comprise less than trivalent Fe. LNO-Fe may contain, for example, divalent Fe. When the valence of Fe is less than 3, a decrease in initial capacity due to addition of Fe can be reduced. This is considered to be because the cation mixing between the Ni site and the Li site is reduced.

### XAFS Measurement

In LNO-Fe, the valence of Fe of less than 3 can be confirmed by XAFS measurement of the positive electrode 10. As a facility capable of XAFS measurement, for example, a beam line “BL11S2” of “Aichi synchrotron light center” or the like can be given.

The positive electrode 10 (electrode plate, sheet) is cut into a predetermined size to prepare a sample for measurement. The XAFS spectrum of the K-absorption edge of Fe is measured by the fluorescence method. The measurement conditions are as follows.
Ring: 1.2 GeV
Measurement range: 7073.26 to 7163.26 eV
Step width: 0.30 eV
Time: 1.00 s

FIG. 2 shows an example of an XAFS spectrum. The abscissa of the graph represents the energy of X-rays. The vertical axis represents absorbance. The absorbance is normalized. “Peak top” indicates a point at which the absorbance exhibits a maximum value in the range of 7110 to 7160 eV. The XAFS spectrum of No. 5 has a peak top in a range of 7140 eV or more. The valence of Fe contained in No. 5 is considered to be 3. LNO-Fe of No. 1 is obtained by reducing LNO-Fe of No. 5. The XAFS spectrum of No. 1 has a peak top in the range of 7132±2 eV (7130 to 7134 eV). The valence of Fe contained in No. 1 is considered to be less than 3. The valence of Fe contained in No. 1 may be 2. In the battery 100 including the positive electrode 10 of No. 1, it is expected that the decrease in initial capacity is reduced. The production conditions of Nos. 1 and 5 will be described later.

As long as the XAFS spectrum at the K-absorption edge of Fe has a peak top in the range of 7132±2 eV, additional elements (dopants) may be added to LNO-Fe. The dopant may include, for example, at least one selected from the group consisting of B, C, N, halogen, Sc, Ti, V, Cu, Zn, Ga, Ge, Se, Sr, Y, Zr, Nb, Mo, In, Sn, W, and lanthanoid. The surface of LNO-Fe (particles) may be coated with, for example, an oxide solid electrolyte (for example, LiNbO₃, Li₃PO₄) or the like.

### 1-2. Negative Electrode

The negative electrode 20 may be, for example, a sheet. The negative electrode 20 may include, for example, a negative electrode current collector and a negative electrode active material layer. The negative electrode current collector may include, for example, a Cu foil. The negative electrode active material layer may be disposed on the surface of the negative electrode current collector. The negative electrode active material layer includes a negative electrode active material. The negative electrode active material may be powdery or sheet-like. The negative electrode active material may contain, for example, at least one selected from the group consisting of natural graphite, artificial graphite, soft carbon, hard carbon, Si, SiOₓ (0<x<2), Si-based alloy, Sn, SnOₓ (0<x<2), Li, Li-based alloy, and Li₄Ti₅O₁₂. The negative electrode active material layer may further include a conductive material, a binder, and the like. The negative electrode active material layer may contain, for example, VGCF, CMC, styrene-butadiene rubber (SBR), or the like.

### 1-3. Electrolyte

The electrolyte 30 may form an ion conducting path between the positive electrode 10 and the negative electrode 20. The electrolyte 30 may be a liquid, a polymer gel, or a solid. The liquid electrolyte may include, for example, a lithium salt and a solvent. The lithium salt may include LiPF₆, for example. The solvent may include, for example, ethylene carbonate (EC), dimethyl carbonate (DMC), ethyl methyl carbonate (EMC), etc. The gel electrolyte may comprise a liquid electrolyte and a polymeric material. The polymeric material may comprise PVdF-HFP, polyethylene oxide (PEO), etc. The solid electrolyte may include, for example, a sulfide Li ion conductor (such as Li₃PS₄). The solid electrolyte may also have a function of separating the positive electrode 10 from the negative electrode 20.

### 1-4. Separator

For example, when the battery 100 includes a liquid electrolyte or a gel electrolyte, the battery 100 may further include a separator (not shown). The separator may include, for example, a porous film. The separator is disposed between the positive electrode 10 and the negative electrode 20. A liquid electrolyte may penetrate the separator. The separator may include, for example, a porous film made of polyolefin.

### 2. Method of Producing a Positive Electrode Active Material

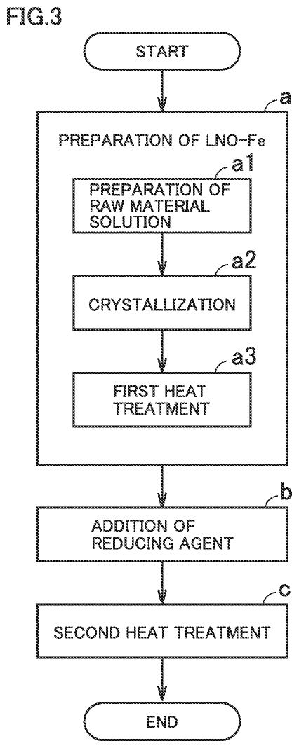

FIG. 3 is a schematic flowchart of a method of producing a positive electrode active material according to the present embodiment. Hereinafter, the “method of producing a positive electrode active material in the present embodiment” may be abbreviated as “the production method”. The production method includes “(a) preparation of LNO-Fe”, “(b) addition of a reducing agent”, and “(c) second heat treatment”.

### 2-1. (a) Preparation of LNO-Fe

The production method includes preparing LNO-Fe. LNO-Fe may be synthesized, for example, or may be obtained from the market. For example, LNO-Fe may be synthesized by coprecipitation. That is, the production method may include, for example, “(a1) preparation of a raw material solution”, “(a2) crystallization”, and “(a3) first heat treatment”.

### (a1) Preparation of Raw Material Solution

For example, a raw material solution can be prepared by dissolving various raw materials in water. For example, a raw material solution may be prepared by dissolving NiSO₄, CoSO₄, MnSO₄, Al₂(SO₄)₃, FeSO₄ or the like in ion-exchanged water. The concentration of the raw material solution may be, for example, a mass fraction of 10 to 40%.

### (a2) Crystallization

For example, ammonia water is placed in a reaction vessel. While the ammonia water is stirred, the inside of the container is replaced with nitrogen. A reaction solution is formed by mixing NaOH with ammonia water. The reaction solution is alkaline. The pH of the reaction solution can be adjusted by the amount of NaOH mixed.

The raw material solution and ammonia water are dropped into the reaction solution so that the reaction solution maintains a pH in a predetermined range. This may produce a coprecipitate. The coprecipitate comprises a metal hydroxide. Metal hydroxides are precursors of LNO-Fe. For example, the coprecipitate may be recovered by filtration. For example, the coprecipitate may be washed with ion-exchanged water. After washing, the coprecipitate is dried to form a dried product.

### (a3) First Heat Treatment

For example, in a mortar, a dry substance and a Li raw material are mixed to form a mixture. The Li raw material may include, for example, LiOH, Li₂CO₃, and the like. For example, in a muffle furnace or the like, the mixture is subjected to a first heat treatment. The LNO-Fe may be synthesized by the first heat treatment. The first heat treatment may also be referred to as “first firing”. The heat treatment temperature may be, for example, 800 to 1100° C. The heat treatment time may be, for example, 8 to 16 hours. After the first heat treatment, the particle size of LNO-Fe may be adjusted by disintegration of LNO-Fe. For example, LNO-Fe may be crushed by a jet mill or the like.

### 2-2. (b) Addition of Reducing Agent

The production method includes mixing LNO-Fe with a reducing agent to form a mixture. For example, LNO-Fe and a reducing agent may be mixed in a mortar. The reducing agent may be a solid or a liquid. The reducing agent may include, for example, at least one selected from the group consisting of L-ascorbic acid, isoascorbic acid, catechin, dibutylhydroxytoluene, tocopherol, and butylhydroxyanisole.

### 2-3. (c) Second Heat Treatment

The production method includes producing a positive electrode active material by heating a mixture (LNO-Fe and a reducing agent) under an inert atmosphere. The second heat treatment can reduce Fe in LNO-Fe. The second heat treatment may also be referred to as “second firing”. In the second heat treatment, trivalent Fe may be reduced to less than trivalent Fe. In the second heat treatment, trivalent Fe may be reduced to divalent Fe.

The second heat treatment may be performed in a muffle furnace or the like. The inert atmosphere may be, for example, an argon atmosphere (Ar), a nitrogen atmosphere (N₂), or the like. The heat treatment temperature may be, for example, 800 to 1100° ° C. The heat treatment time may be, for example, 8 to 16 hours. The particle size of the positive electrode active material may be adjusted by pulverizing the positive electrode active material after the second heat treatment. For example, the positive electrode active material may be crushed by a jet mill or the like.

### EXAMPLES

### 3. Preparation of Samples

Positive electrode active materials of Nos. 1 to 11 were produced as follows. Hereinafter, for example, “positive electrode active material according to No. 1” and the like may be abbreviated as “No. 1” and the like.

### No. 1

NiSO₄, CoSO₄, MnSO₄ and FeSO₄ were dissolved in ion-exchanged water to form a raw material solution. In the raw material solution, the molar ratio of Ni, Co, and Mn was “Ni/Co/Mn=1/1/1”. The solute concentration in the raw material solution was 30% (mass fraction).

Ammonia water was placed in the reaction vessel. While the ammonia water was stirred by the stirrer, the inside of the reaction vessel was replaced with nitrogen. Further, NaOH was charged into the reaction vessel to form a reaction solution.

A coprecipitate was formed by dropping the raw material solution and ammonia water into the reaction solution so that the reaction solution was kept at a pH within a certain range. The reaction solution was filtered to recover the coprecipitate. The coprecipitate was dispersed in ion-exchanged water to form a dispersion. The dispersion was sufficiently stirred by a spatula. That is, the coprecipitate was washed with water. After washing with water, the dispersion was filtered to recover coprecipitate. The coprecipitate was dried at 120° C. for 16 hours to form a dried product.

The dry matter and Li₂CO₃ were mixed in a mortar. This formed a mixture. In a muffle furnace, LNO-Fe was synthesized by subjecting the mixture to a first heat treatment. LNO-Fe had a composition of Li(Ni_{1/3}CO_{1/3}Mn_{1/3})_{1-y}Fe_{y}O₂. The content of Fe was a mass fraction of 1%. The heat treatment temperature was 950° ° C. The heat treatment time was 10 hours. After the first heat treatment, LNO-Fe was crushed by jet mill.

LNO-Fe and a reducing agent (ascorbic acid) were mixed to form a mixture. In the muffle furnace, the mixture was subjected to a second heat treatment to produce a positive electrode active material. The heat treatment atmosphere was a nitrogen atmosphere. The heat treatment temperature was 950° C. The heat treatment time was 10 hours. After the second heat treatment, the positive electrode active material was crushed by a jet mill.

### No. 2 to 4

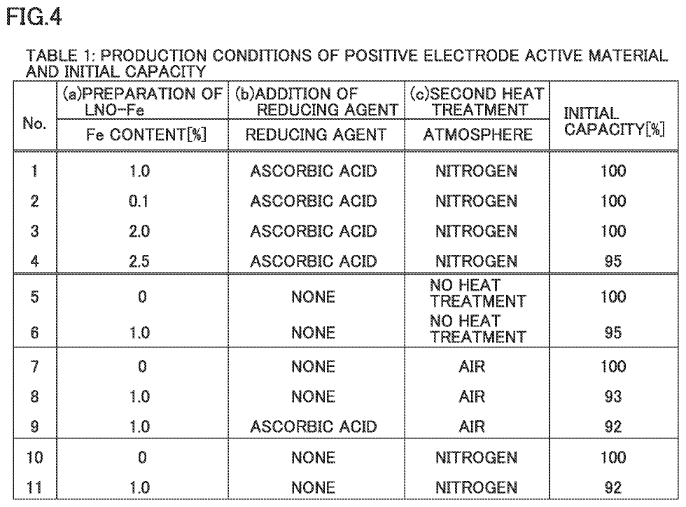

FIG. 4 is a table showing the production conditions of the positive electrode active material and the initial capacity. A positive electrode active material was produced in the same manner as in No. 1 except that the content (amount of addition) of Fe in LNO-Fe was changed.

### No. 5

Coprecipitates without Fe were synthesized. LNO was synthesized by subjecting the coprecipitate to a first heat treatment. LNO had a composition of Li(Ni_{1/3}Co_{1/3}Mn_{1/3})O₂. The positive electrode active material was produced by pulverizing LNO using a jet mill. No second heat treatment was performed on LNO.

### No. 6

Coprecipitates containing Fe were synthesized. LNO-Fe was synthesized by subjecting the coprecipitate to a first heat treatment. LNO-Fe had a composition of Li(Ni_{1/3}Co_{1/3}Mn_{1/3})_{1-y}Fe_{y}O₂. The content of Fe in LNO-Fe was a mass fraction of 1%. The positive electrode active material was produced by pulverizing LNO-Fe. No second heat treatment was performed on LNO-Fe.

### No. 7

The LNO of No. 5 was subjected to the second heat treatment. The second heat treatment was performed under an air atmosphere. The heat treatment temperature was 950° C. The heat treatment time was 10 hours. After the second heat treatment, LNO was crushed to produce a positive electrode active material.

### No. 8

The LNO-Fe of No. 6 was subjected to the second heat treatment. The second heat treatment was performed under an air atmosphere. The heat treatment temperature was 950° C. The heat treatment time was 10 hours. After the second heat treatment, LNO-Fe was crushed to produce a positive electrode active material.

### No. 9

LNO-Fe of No. 6 and a reducing agent (ascorbic acid) were mixed to form a mixture. The mixture was subjected to a second heat treatment. The second heat treatment was performed under an air atmosphere. The heat treatment temperature was 950° C. The heat treatment time was 10 hours. After the second heat treatment, LNO-Fe was crushed to produce a positive electrode active material.

### No. 10

The LNO of No. 5 was subjected to the second heat treatment. The second heat treatment was performed under a nitrogen atmosphere. The heat treatment temperature was 950° C. The heat treatment time was 10 hours. After the second heat treatment, LNO was crushed to produce a positive electrode active material.

### No. 11

The LNO-Fe of No. 6 was subjected to the second heat treatment. The second heat treatment was performed under a nitrogen atmosphere. The heat treatment temperature was 950° C. The heat treatment time was 10 hours. After the second heat treatment, LNO-Fe was crushed to produce a positive electrode active material.

### 4. Evaluation

Test batteries including the positive electrode active materials Nos. 1 to 11 were produced. The initial capacity of the test battery was measured. In the table of FIG. 4, the value of the initial capacitance is a relative value to the value of No. 1.

The configuration of the test battery was as follows.

### Cylindrical Lithium Ion Batteries

Power generation element: Winding Model
Positive electrode: Positive electrode active material/AB/PVDF=88/10/2 (mass ratio)
Negative electrode: Negative electrode active material (natural graphite), CMC, SBR
Electrolyte: LiPF₆ (1 mol/L), EC/DMC/EMC=3/4/3 (volume ratio)

The positive electrode and the negative electrode were produced by applying a slurry to the surface of a current collector (metal foil). A film applicator (with a film thickness adjusting function) produced by Allgood Corporation was used as a coating apparatus. After the slurry was applied, the coating was dried at 80° C. for 5 minutes.

### 5. Results

In the table of FIG. 4, for example, in comparison between No. 5 and No. 6, when Fe is added to LNO, the initial capacity tends to decrease.

In Nos. 1 to 4, the decrease in initial capacity due to the addition of Fe is reduced. It is considered that Fe was reduced to less than trivalent by the second heat treatment (reducing agent and inert atmosphere).

In No. 9, the initial capacity decreased. The second heat treatment of No. 9 is not an inert atmosphere.

In No. 11, the initial capacity decreased. In the second heat treatment of No. 11, no reducing agent was used.

XAFS measurements of the positive electrode were performed. In Nos. 1 to 4, the XAFS spectrum of the K-absorption edge of Fe had a peak top in the range of 7132±2 eV. In Nos. 5 to 11, the XAFS spectrum at the K-absorption edge of Fe had a peak top outside the range of 7132±2 eV. The XAFS spectra of the K-absorption edges of Fe in Nos. 1 and 5 are shown in FIG. 2.

What is claimed is:

1. A battery comprising a positive electrode, a negative electrode, and an electrolyte, wherein
the positive electrode includes a positive electrode active material,
the positive electrode active material includes a lithium nickel composite oxide,
the lithium nickel composite oxide includes iron, and
an X-ray absorption fine structure spectrum at a K-absorption edge of the iron in the positive electrode has a peak top in a range of 7132±2 eV.

2. The battery according to claim 1, wherein the lithium nickel composite oxide includes the iron at a mass fraction of 1 to 2%.

3. The battery according to claim 1, wherein the lithium nickel composite oxide includes at least one selected from a group consisting of a lithium-nickel-cobalt-manganese composite oxide and a lithium-nickel-cobalt-aluminum composite oxide.

4. A method of producing a positive electrode active material, the method comprising in the following order:
(a) preparing a lithium nickel composite oxide including iron;
(b) forming a mixture by mixing the lithium nickel composite oxide with a reducing agent; and
(c) producing the positive electrode active material by heating the mixture under an inert atmosphere.

5. The method of producing the positive electrode active material according to claim 4, wherein
the lithium nickel composite oxide includes at least one selected from a group consisting of a lithium-nickel-cobalt-manganese composite oxide and a lithium-nickel-cobalt-aluminum composite oxide,
the lithium nickel composite oxide includes the iron at a mass fraction of 1 to 2%, and
the reducing agent includes an ascorbic acid.
